(19) United States
(12) Patent Application Publication
(10) Pub. No.: US 2012/0078646 A1
(43) Pub. Date: Mar. 29, 2012

(54) SYSTEM AND A METHOD FOR REAL TIME HEALTHCARE BILLING AND COLLECTION

(75) Inventors: Rajesh Kanaka Toleti, Windermere, FL (US); Chakravarthy Srinivasa Kalyan Toleti, Windermere, FL (US); Nageshwara Rao Vempaty, Saratoga, CA (US)

(73) Assignee: Greatwater Software Inc., Orlando, FL (US)

(21) Appl. No.: 12/891,074

(22) Filed: Sep. 27, 2010

(51) Int. Cl. G06Q 50/00; G06Q 10/00

(52) U.S. Cl. 705/2

(57) ABSTRACT

A system and a method for real time or near real time healthcare billing, adjudication and collection of payments is presented to reduce revenue cycle time. In the preferred embodiment, the system includes one or a plurality of mobile devices, computing devices, kiosks, servers, networks and software to provide a medium for real time collaboration between the provider and the coder/coding engine. The method consists of transferring the diagnosis codes and the procedure codes in real time while they are being entered by the provider to the coder/coding engine and the coder/coding engine collaborating with the provider in creating charges for the encounter in real time during the encounter, followed by creating claim(s) for the encounter and submitting to the payer(s) in real time or near real time at the end of the encounter and the collection of the patient's obligation based on the payer(s) explanation of benefits.

### SUMMARY OF THE INVENTION

Our invention consists of a system and a method for real time billing, adjudication and collection of payments from payer(s) and patients during a patients' encounter with a healthcare provider. The current process for generating healthcare claims for an encounter is time consuming and involves manual paper based processes. The current process can take several days before a claim is generated and the patient liability is sent to the patient by means of a patient statement via postal mail or email. Our invention replaces this with a semi automated real time collaborative process, with an electronic computer network connecting the provider to a coder, where the entire process is run in real time during the patient's encounter. It enables the provider to send the charge capture information required for billing in real time to a coder. The coder and/or the system then prepare the list of charges collaboratively with the provider, prepare a claim or a plurality of claims and submit them on the provider's behalf to the payer(s). The system consists of a computer or a several computers or a handheld device or several handheld devices or a kiosk or several kiosks, and a server or several servers, all connected by an electronic computer network to enable real time communication. The method consists of enabling the provider to enter diagnosis and procedure codes in real time during the encounter, to collaborate with a coder/system to produce the charges and subsequently the claim(s) and to submit the claim at the end of the encounter to the payer(s). Subsequently, if appropriate, the method continues to near real time adjudication of the claim by the payer or a plurality of payers, the presentation of the explanation of benefits (EOB) to the patient and the patient liability including coinsurance, deductibles, and copayment(s) may be collected from the patient at the point of check-out via a check-out kiosk (mobile device/computer system). Our invention increases the efficiency and reduces the time taken by healthcare providers in generating claims for encounters and collecting payments, thereby improving their revenue(s) and the revenue cycle of the practice.

### BACKGROUND

Billing for healthcare services is a time consuming, laborious, error prone and costly process. This is especially the case in the United States of America (USA), involving third party payment from payers. In the typical paper driven manual processes currently in vogue, the claim generation, submission, and adjudication are post processing steps that are done after a patient encounter is completed. During the encounter, the provider accumulates the details of diagnosis found and procedures provided in a superbill. The superbill is handed over to the billing department or a third party billing company to create one or more healthcare claims. The superbill is often handed over on paper. The billing personnel create claims using one of several appropriate formats. The billing personnel typically need to re-enter data about the patient encounter, including but not limited to the demographics of the patient, the dates of the encounter, the diagnostics code(s) and the procedure code(s), and any referral/authorization if applicable. The handover of superbills is often done on a weekly basis involving several days of delay. The creation of the claim itself can take several days. The claim(s) is (are) then submitted to the payer or multiple payers if appropriate for adjudication. Several payers support electronic means for submitting claims. The payer adjudicates the claim and returns an explanation of benefits and a payment to the provider. The two may happen separately, electronically or manually, and can take several days or weeks. The EDI standard in the United States for submitting a claim is ANSI X12 837 and for receiving the explanation of benefits (EOB) is ANSI X12 835. The provider then figures the difference in payment received and sends paper statements or electronic statements for collecting the patient liability from the patient. This is then submitted to the patient along with relevant EOB, typically on paper or via a bill pay website. The patient then may send a payment to the provider. In the United States, there are often complications and confusion resulting from multiple payers, from per incident and annual deductibles associated with healthcare plans, and from eligibility and order of precedence associated with healthcare plans. The entire process can potentially take several days or several months. This extends the collection time for healthcare providers into several days or months. Delays and errors often lead to a percentage of healthcare services not being paid at all. It is desirable to automate the process and speed up the process of generation and submission of claims from the provider's point of view as well as from the coder's point of view. More importantly our invention makes it very clear to the patient their liability at the time of service and lets the patient pay their portion at the same time.

There are several mechanisms mentioned in prior art dealing with the real time, near real time or electronic process for submission and/or adjudication of healthcare claims to payers. Our invention can work in concert with or interfacing with one or more such payer claims processing systems. Our invention can also work in conjunction with practice management systems and electronic medical record (EMR) systems, patient check-in systems and patient admission, discharge and transfer (ADT) systems, financial accounting systems and other healthcare IT systems mentioned in prior art. The interfacing with such systems can be via real time electronic transactions, XML and/or TCP/IP messaging based communication and/or by electronic file transfer.

There are several solutions proposed for real time claims adjudication and payment in prior art. Most of them work with electronic backend submission mechanisms being enabled by payers. They propose electronic means for submitting a claim from a provider to a payer and receiving an acknowledgment or explanation of benefits in response back to the provider. Kennedy and Bartlett present one such system in reference [1]. Their invention works by using a point of sale (POS) system at the provider's office. When the patient information and procedure codes from a claim are entered into the POS, the POS sends an electronic claim to a payer's backend system that it is prewired into, gets and explanation of benefits (EOB) as a response and presents the EOB to the patient to collect the patient portion of the payment if there is any. The critical difference in our invention is the ability to provide the EOB to the patient via a kiosk at check-out as well as the ability for the coder to create the charges collaboratively in real time while the provider is interacting with the patient, the coder generating the claim(s) from charges, and the coder submitting the claim(s) in real time or near real time. The coder/system continues with adjudication and payment in real time during the encounter or near real time at the end of the encounter or post encounter as they deem fit. Our inventions uniqueness is in enabling a coder to interact and help the physician capture charges from the physician and also to provide feedback to the physician on what else needs to be covered to maintain compliance with certain guidelines and regulations while providing patient care. The healthcare provider can choose to implement this in full or in partial during the encounter or at the end of encounter. The provider can choose to implement parts of these processes after the encounter as well or by manual means. The flexibility is enabled in our invention by means of a semi-automated orchestration process, which may be implemented to provide automation for all the steps mentioned or a pre-selected subset of the steps or a dynamically selected subset of the steps as needed by the said provider.

### BRIEF DESCRIPTION OF THE DRAWINGS

FIG. 1 illustrates one specific embodiment of our invention, where the provider and coder collaborate using our system.

FIG. 2 illustrates by means of a flow diagram a method for real time collaborative construction of healthcare charges and claim(s) during a patient encounter.

FIG. 3 illustrates a specific embodiment of our invention, where our system provides hints and guidelines for compliance to payer rules and regulations.

FIG. 4 illustrates a specific embodiment of our invention, where our system provides a method to collect patient's obligation at a kiosk during check-out.

### DETAILED DESCRIPTION OF THE PREFERRED EMBODIMENTS

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The preferred embodiment of the invention will now be described with reference to the figures in which like numbers correspond to like references throughout.

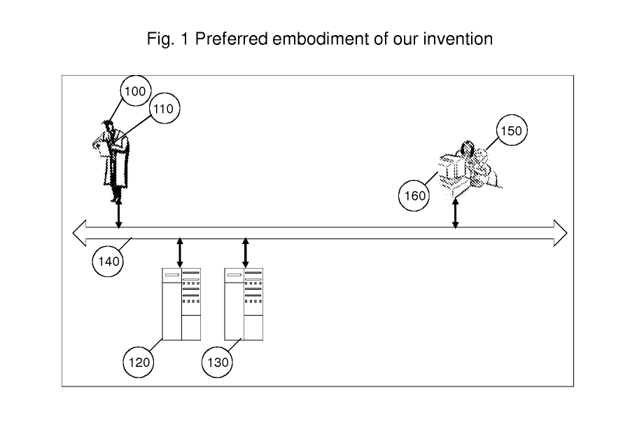

During a physician-patient encounter, the physician 100 in FIG. 1 uses an electronic clipboard or a mobile device. The physician enters diagnostic codes and procedure codes. These are transmitted in real time to the backend real time processing software of our invention 120, which activates a coder 150. There may be additional systems such as a practice management system 130. The physician's mobile device 110, the coder's computer 160, the backend software 120 and other systems are connected by a computer network 140. The backend software 120 and the coder 150 can process in real time or in near real time the charges with the diagnostic codes and the procedure codes, during the encounter between the provider and the patient.

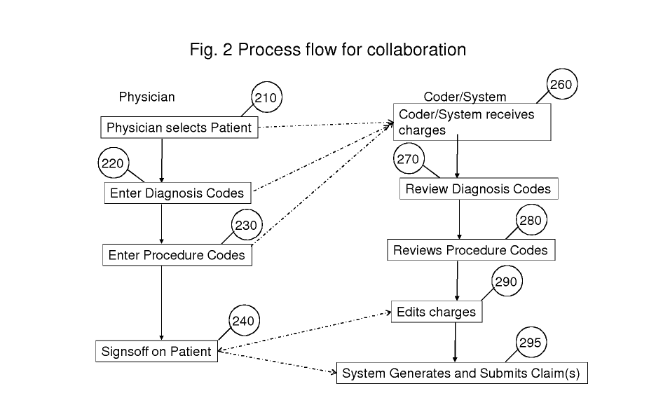

The collaboration workflow between the physician and the coder/system is illustrated in FIG. 2. When the physician starts the encounter with the patient, he/she opens the patient record on an electronic clipboard or a mobile device or a computer. This triggers the system or a coder to start the claim generation in real time or near real time. The coder may be nearby or far away or the function of the coder may automated by the system. When the physician enters diagnosis codes in step 220 and procedure codes in step 230, these are immediately available for review by the coder/system in step 270 and step 280 respectively. As soon as the physician signs off on the patient in step 240, the coder/system can review the charges in step 290 and generate the claim and submit it in step 295. If the payer for the claim supports real time adjudication, this can be done and the result of the adjudication can be used to compute, present and collect the patient portion of the payment obligation while the patient is still in the physician office. Without loss of generality, there may be a plurality of claims generated during certain encounters; if a payer does not support real time adjudication, the claim is posted later for processing.

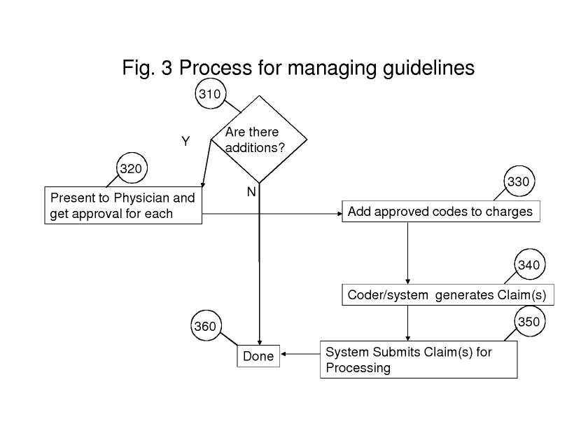

In an embodiment of our invention, the coder or the system can suggest additional procedure codes or diagnosis codes found relevant to the encounter from one or more knowledge bases and/or rule bases. These may be guided by quality rules or policies of the payers or government organizations or hospitals. This is illustrated in FIG. 3. The system runs through the charges of step 290 in FIG. 2 and suggests additional procedure codes and/or diagnosis codes if found in step 310. (The coder may optionally approve this list, add to this list or create this list manually.) The physician has the choice of approving and performing additional medical diagnosis and procedure(s) in step 320. The codes approved and performed by the physician are added to the charges in step 330. The improved charges presented to the coder/system in step 340, for generating claim(s) which are submitted for adjudication in step 350. If the payer(s) in the claim(s) supports real time adjudication, the claim(s) is submitted electronically for real time adjudication and the explanation of benefits (EOB) is obtained electronically in real time.

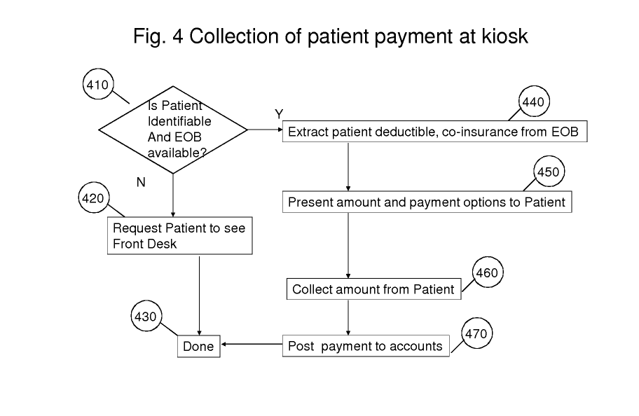

FIG. 4 illustrates the process for collection of patient's obligation at a kiosk in an embodiment of our invention. The patient is directed to a check out kiosk at the end of the encounter. The patient is requested to identify himself/herself in step 410. If the patient cannot be successfully identified or if the EOB is not available, then he/she is directed to go to the front desk for further processing (and the front desk is optionally notified) in step 420. If the patient is identified and the EOB is available, the amount of patient's obligation is computed and/or estimated based on the EOB information available in step 440. If payer supports real time adjudication, the amount of patient obligation due to deductible(s), co-insurance(s), etc., can be computed. This is presented to the patient in step 450. The kiosk may be provisioned to accept payment by one or more means, including cash, check, credit card, debit card, benefits card, bill-me-later service, etc. The options available are presented to the patient and the payment is collected from the patient in step 460. The amount collected is posted to the accounting system in step 470.

We described specific embodiments of the invention along with specific examples in the specific domain of healthcare. Practitioners of the art can apply our invention to several other examples that may differ in several ways from the examples we discussed, including but not limited to the type of encounter, the type of appointment or procedure, the details of the information available, etc. Practitioners of the art can derive several embodiments and domains of applicability of our invention. An alternate embodiment of the invention may not use a kiosk. Yet another alternate embodiment of the invention may not use a backend IT system or may use one or more backend IT systems and/or other systems. Practitioners of the art can apply our invention to such alternate embodiments also.

The illustrations, and block diagrams of FIGS. 1, 2, 3 and 4 illustrate the architecture, functionality, and operation of possible implementations of apparatus, systems, methods and computer program products according to various embodiments of the present invention. In this regard, each block in the flow charts or block diagrams may represent a module, electronic component, segment, or portion of code, which comprises one or more executable instructions for implementing the specified function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

In the drawings and specification, there have been disclosed typical illustrative embodiments of the invention and, although specific terms are employed, they are used in a generic and descriptive sense only and not for purposes of limitation, the scope of the invention being set forth in the following claims.

### A Note Regarding Claims

In the discussions contained in this Patent Application we have included many major elements which obviously are bases for claims as we technically understand them. In addition, as is customary practice, we request that the Patent Examiner point out any resulting claims we may have inadvertently missed, and that he/she point out any relevant changes that should be made to clarify the submitted claims, and that he/she point out any unintended duplication of claims should such inadvertently occur.

What is claimed is:

1. A system and a method for real time or near real time charge capture, claim generation, claim adjudication, and collection of payment from patient where
The system consists of an electronic network of a kiosk or a plurality of kiosks, a computer or a plurality of computers or a mobile device or a plurality of mobile devices for collaborative interaction between provider, coder and patient, one or a plurality of computer servers and electronic networks
The method consists of an electronic semi-automated collaborative process between a physician and a coder or a coding system for generation of charges during the encounter, the generation of claim(s), submission of claim(s) to payer(s) for real time adjudication, the reception of EOB(s) from payer(s), computing the patient payment amount from the EOB(s) and collection of patient payment at a check out kiosk (or a computer or a mobile device).

2. The method of claim 1, where the construction of the claim from the charges is performed in real time during the patient encounter.

3. The method of claim 2, where bundling of procedure codes in the claim(s) is performed for various business reasons in an automated or semi-automated fashion.

4. The method of claim 1, where there is a plurality of providers treating a patient during an encounter.

5. The method of claim 1 under certain circumstances such as child birth or separation of conjoined twins, where multiple patients are involved in encounter and hence one or more claim(s) are generated.

6. The method of claim 1, where one or a plurality of steps are performed manually or modified or skipped or their execution order is changed to suite business needs.

7. The method of claim 1, where one or a plurality of coders in a pool are available to produce the charges and the claim(s) with the provider and a selection policy such as the next available coder, round robin, random or least busy coder is selected in real time to collaboratively work with the provider.

8. The method of claim 7, where the coder may be on premises of the point of care or may be remotely located from the point of care or pools of coders may be available at different geographic locations or times, the said coders connecting over the network of the said system and electronically interacting with the providers and the encounters that they are allocated to bill for.

9. The method of claim 1, where the system is programmed to run rules to check compliance with the relevant payer rules and/or regulations, and provides suggestions to the coder and/or the provider to improve compliance to the said rules and/or regulations in real time during the encounter with the said patient.

10. The method of claim 9, where the system and/or the coder provide real time feedback to the provider to improve the probability of reimbursement or the amount of reimbursement for the provider.

11. The method of claim 1, where the system will also evaluate quality measures and present pay for performance questions at check out and check in to the patient. Results may be included in further processing.

12. The method of claim 1, where the details of the procedures, the claims, the adjudication results such as the payments and the explanation of benefits from the payer are presented to the patient on a kiosk or a mobile device or a computer during the check out process.

13. The method of claim 1, where patient obligations such as co-insurance, deductibles, co-pays, etc., for the encounter are presented to the patient at a check out kiosk or a mobile device or a computer.

14. The method of claim 13, where a payment is collected from the patient using credit cards or debit cards or checks or cash or PayPal or bill me later or other modes of payment or a combination of one or more payment modes.

15. The method of claim 14, where an allocation of the payment or payments is made to different bills, such as past due bills.

16. The method of claim 1, where the explanation of benefits and/or payment is printed to be handed to the patient.

17. The method of claim 1, where the explanation of benefits and/or payment is sent to the patient by electronic means such as email.

18. The method of claim 1, where an estimation of the explanation of benefits and the patients obligation is computed by an algorithm and presented to the patient instead of or in addition to the data from EOB(s).

19. The method of claim 1, where some of the software implementing the processes is hosted and provided as a service over a network of computers.

20. The method of claim 19, where multiple providers are served by the same hosted service.
